(19) United States
(12) Patent Application Publication
(10) Pub. No.: US 2021/0317269 A1
(43) Pub. Date: Oct. 14, 2021

(54) OPTICALLY TRANSPARENT POLYIMIDES

(71) Applicant: Zymergen Inc., Emeryville, CA (US)

(72) Inventors: Arjan Zoombelt, Emeryville, CA (US); Steven M. Edgar, Albany, CA (US); Alejandra Alvarez Albarran, Emeryville, CA (US)

(73) Assignee: Zymergen Inc., Emeryville, CA (US)

(21) Appl. No.: 17/250,589

(22) PCT Filed: Aug. 6, 2019
(86) PCT No.: PCT/US2019/045341

§ 371 Date: Feb. 5, 2021

Related U.S. Application Data
(60) Provisional application No. 62/715,632, filed on Aug. 7, 2018.

(51) Int. Cl. C08G 73/10; C08J 5/18; C08L 79/08

(52) U.S. Cl. CPC C08G 73/1078; C08J 5/18; C08G 73/1067; C08L 2205/03; C08J 2379/08; C08J 2479/08; C08L 2205/025; C08L 79/08

(57) ABSTRACT

A polymer film comprising at least two properties selected from (i) a thickness of not greater than 100 μm; (ii) a tensile modulus according to ASTM D882 of at least 5 GPa; (iii) a first optical transparency according to ASTM D1746-15 at 380 nm of less than 50%; (iii) a Yellowing Index according to ASTM E313-15e1 of not greater than 2.5; (iv) a haze as determined according to ASTM D1003-13 of not greater than 1.5%; (v) a pencil hardness of greater than 1H; (vi) a coefficient of moisture expansion (‘CME’) as determined according to ASTM D5229/D5229M-14 of not greater than 50 ppm; (vii) an elongation at break as determined according to ASTM D5034-09 (2017) of at least 10%; or (viii) a folding endurance as determined according to ASTM D2176-16 at a radius of 1 mm of at least 10,000 folds.

### CROSS-REFERENCE TO RELATED APPLICATIONS

This application claims the benefit of U.S. provisional application No. 62/715,632, filed Aug. 7, 2018, which is hereby incorporated by reference in its entirety.

### STATEMENT AS TO RIGHTS TO INVENTIONS MADE UNDER FEDERALLY SPONSORED RESEARCH AND DEVELOPMENT

This invention was made with Government support under Agreement No. HR0011-15-9-0014, awarded by DARPA The Government has certain rights in the invention.

### FIELD OF THE DISCLOSURE

The present disclosure relates to clear and optically transparent polyamides, polyimides, polyamide-imides, or any combination thereof comprising an arylalkylamide, arylalkylimide, or a combination thereof.

### BACKGROUND

The vast majority of conventional polyimides are highly colored materials with diminished optical clarity in the UV-Visible spectrum. As a result, such polyimides are undesirable as optical materials for applications involving optical waveguides in optical communications and optical computing and as flexible substrates or as components for organic light-emitting diode (OLED) and active-matrix liquid-crystal (AM-LCD) displays. Another limitation of these polyimides is they are unsuitable as transparent substrates for UV-cured coatings and adhesives because their UV absorbance interferes with the efficiency of the photoinitiators used for UV-cured coatings and adhesive

Another limitation of such polyimides is that they are highly rigid polymers and therefore relatively insoluble. This limitation requires solution-processing as the polyamic acid polyimide precursor into a polymer material, such as a film. The polymer material is then thermally converted into the insoluble polyimide at temperatures in excess of 200° C. This high-temperature conversion prevents incorporation of these polyimides into state-of-the art applications, such as flexible electronics, flexible-hydride electronics, flexible circuits, and wearable electronics, all of which use low-temperature processing.

### SUMMARY

Various aspects and embodiments contemplated herein may include, but are not limited to one or more of the following:

In a first aspect, a polymer comprises a moiety selected from the group consisting of general formula (I):

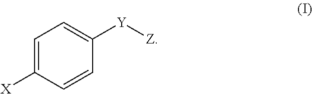

Within the moiety, group X of general formula (I) can be selected from Z,

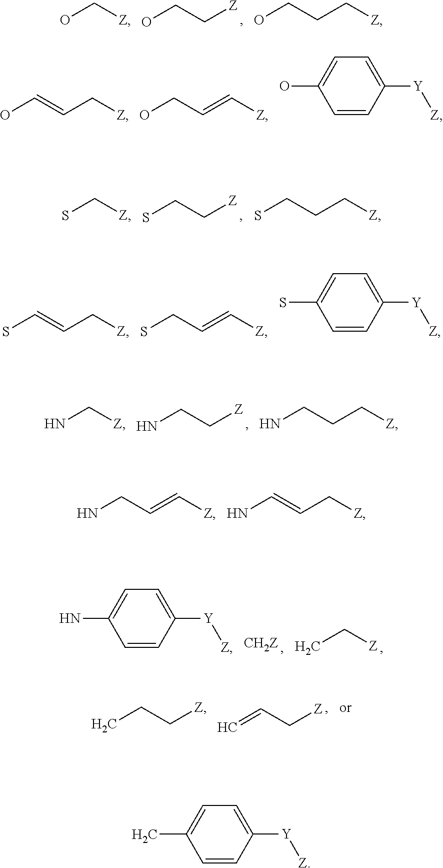

Group Y in general formula (I) and where applicable in group can be selected independently for each occurrence from CH₂, CH₂CH₂,

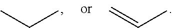

Group Z in general formula (I) and where applicable in group X can be selected independently for each occurrence from an amine, an amide, an imide, a carbamate, or a urea.

In a second aspect, a method for making an optically transparent films comprises polymerizing a first copolymer with a second copolymer. The first copolymer is selected from the group consisting of formula (I). Group X and Y can be selected as described above. Group Z in the method can be selected independently for each occurrence from an amine or a hydroxyl.

In a third aspect, a polymer film comprises at least two properties selected from:

(i) a thickness of not greater than 100 μm, not greater than 90 μm, not greater than 80 μm, not greater than 70 μm, not greater than 60 μm, not greater than 50 μm, not greater than 40 μm, not greater than 35 μm, not greater than 30 μm, or not greater than 25 μm;

(ii) a tensile modulus according to ASTM D882 of at least 5 GPa, at least 5.2 GPa, at least 5.4 GPa, at least 5.6 GPa, at least 5.8 GPa, at least 6 GPa, at least 6.2 GPa, at least 6.4 GPa, at least 6.6 GPa, at least 6.8 GPa, at least 7 GPa, at least 7.2 GPa, at least 7.4 GPa, at least 7.6 GPa, at least 7.8 GPa, at least 8 GPa, at least 8.2 GPa, at least 8.5 GPa, at least 9 GPa, or at least 10 GPa;

(iii) a first optical transparency according to ASTM D1746-15 at 380 nm of less than 50%, less than 40%, less than 35%, less than 30%, less than 25%, less than 20%, less than 15%, less than 10%, less than 8%, less than 6%, less than 4%, less than 2%, or less than 1%, and a second optical transparency according to ASTM D1746-15 at 400 nm of greater than 50%, greater than 60%, greater than 70%, greater than 80%, greater than 82%, greater than 84%, greater than 86%, greater than 88%, greater than 90%, greater than 92%, greater than 94%, greater than 96%, or greater than 96%;

(iii) a Yellowing Index according to ASTM E313-15e1 of not greater than 2.5, not greater than 2.4, not greater than 2.3, not greater than 2.2, not greater than 2.1, not greater than 2.0, not greater than 1.9, not greater than 1.8, not greater than 1.7, not greater than 1.6, not greater than 1.5, not greater than 1.4, or not greater than 1.3;

(iv) a haze as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%;

(v) a pencil hardness of greater than 1H, greater than 2H, greater than 3H, greater than 4H, greater than 5H, or greater than 6H;

(vi) a coefficient of moisture expansion (‘CME’) as determined according to ASTM D5229/D5229M-14 of not greater than 50 ppm, not greater than 45 ppm, not greater than 40 ppm, not greater than 35 ppm, not greater than 30 ppm, not greater than 25 ppm, not greater than 20 ppm, or not greater than 15 ppm;

(vii) an elongation at break as determined according to ASTM D5034-09 (2017) of at least 10%, at least 15%, at least 20%, at least 22%, at least 24%, at least 26%, at least 28%, at least 30%, at least 35%, or at least 40%;

(viii) a folding endurance as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

### DETAILED DESCRIPTION

The disclosure describes novel polyimides that have arylalkyl amido or arylalkyl imido content and have superior transparencies in the Visible spectrum and low transparencies in the UV spectrum. Moreover, polyimides according to the present disclosure have superior mechanical properties. As a result, polyimides according to the present disclosure impart functionalities to become an alternative to glass screens or to Organic Light Emitting Diode (‘OLED’).

In a first aspect, a polymer comprises a moiety selected from the group consisting of general formula (I):

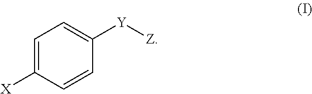

Within the moiety, group X of general formula I can be selected from Z,

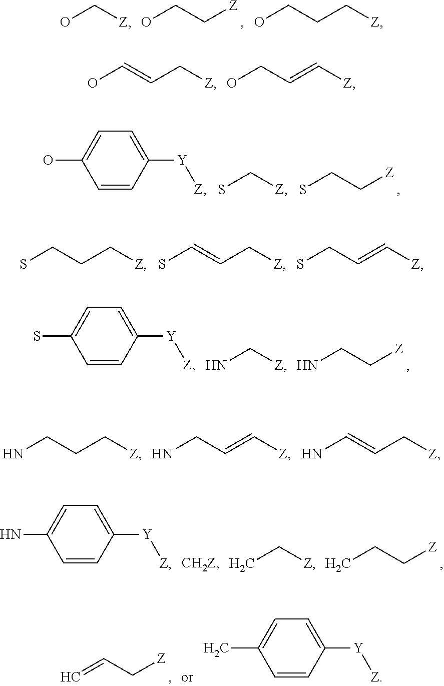

Group Y in general formula (I) and where applicable in group X can be selected independently for each occurrence from CH₂, CH₂CH₂,

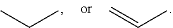

Group Z in general formula (I) and where applicable in group X can be selected independently for each occurrence from an amine, an amide, an imide, a carbamate, or a urea.

In one embodiment, the polyimide can be prepared from a diamine comprising a moiety according to formula (I). In one embodiment, the diamine can be selected from:

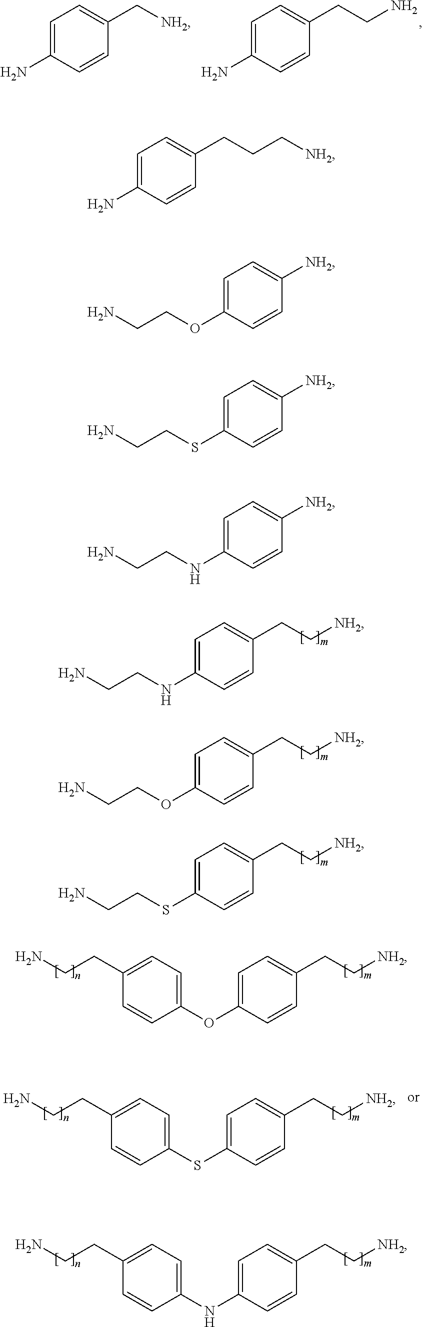

wherein m and n are independently for each occurrence selected from 0, 1, 2, 3, or 4.

Diamines comprising a para-aminomethyl phenoxy group, a para-aminoethyl phenoxy group, or even a para-aminopropyl phenoxy group can be obtained from 4-hydroxybenzylamine, tyramine, or homotyramine as sketched out in the following scheme:

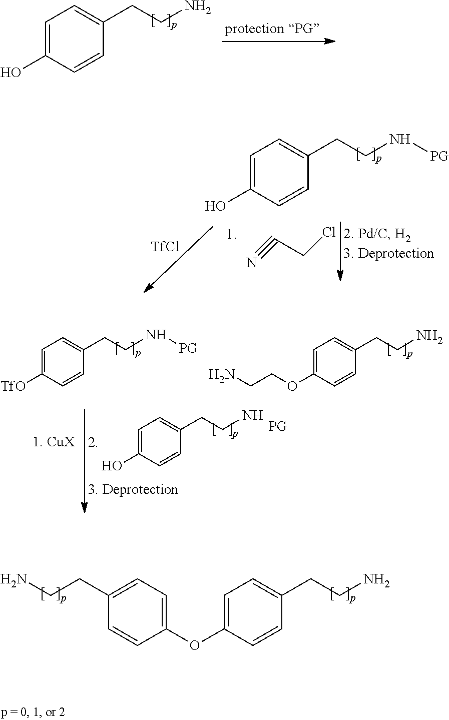

In one embodiment, the polymer or polymer film is made from two diamines. The two diamines can be in different ratios. For example, if aminoethylaniline is the first diamine and O-aminoethyl-tyramine is the second diamine, the first and the second diamine can be in a molar ratio from 1:10 to 10:1, such as from 1:5 to 5:1, 1:3 to 3:1, or 1:2 to 2:1. Likewise, the first and the second diamine can be selected from any of the foregoing diamines.

The principle of varying the type and ratios of diamines results in a polyimide or polyamideimide with reduced pi electron interaction. For optical films, pi electron interaction affects transparency and color of a film. Pi electron interactions within a polyimide chain is reduced by implementing aliphatic groups to distant the pi electrons from one cursor from the pi electrons of another. Pi electron interaction between two chains of polyimide are usually pi-pi stacking of aromatic moieties. Such interaction can be reduced by varying the regularity of aromatic groups by introducing diamines with various length of aminoalkyl groups.

Accordingly, one further aspect of the present disclosure is a method for producing a polyimide or a polyamideimide having a Yellowing Index according to ASTM E313-15e1 of not greater than 2.5, not greater than 2.4, not greater than 2.3, not greater than 2.2, not greater than 2.1, not greater than 2.0, not greater than 1.9, not greater than 1.8, not greater than 1.7, not greater than 1.6, not greater than 1.5, not greater than 1.4, or not greater than 1.3. The method comprises polymerizing the polyimide from a first and a second diamine, the first and second diamines are different in structure and independently selected from the group consisting of general formula (I):

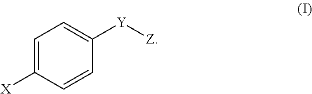

Within the moiety, group X of general formula (I) can be selected from Z,

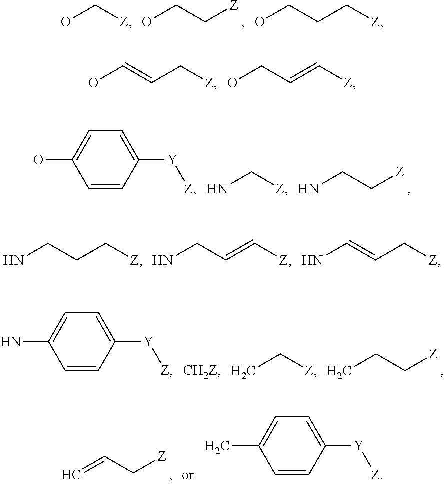

Group Y in general formula (I) and where applicable in group X can be selected independently for each occurrence from CH₂, CH₂CH₂,

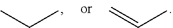

Group Z in the method can be selected independently for each occurrence from an amine or a hydroxyl.

The first and the second diamine can be in a molar ratio from 1:10 to 10:1, such as from 1:9 to 9:1, from 1:8 to 8:1, from 1:7 to 7:1, from 1:6 to 6:1, from 1:5 to 5:1, from 1:4 to 4:1, from 1:3 to 3:1, from 1:2 to 2:1, from 2:3 to 3:2, from 3:4 to 4:3, or from 4:5 to 5:4.

In yet another embodiment, the method includes a third diamine. Accordingly, the first and the third diamine can be in a molar ratio from 1:10 to 10:1, such as from 1:9 to 9:1, from 1:8 to 8:1, from 1:7 to 7:1, from 1:6 to 6:1, from 1:5 to 5:1, from 1:4 to 4:1, from 1:3 to 3:1, from 1:2 to 2:1, from 2:3 to 3:2, from 3:4 to 4:3, or from 4:5 to 5:4. In one particular embodiment, the first, the 10 second, and the third diamine are in a molar ratio of about 1:1:1.

Alternatively, the present disclosure includes a method for producing a polyimide or a polyamideimide having a haze as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Polyimides can be prepared by reacting the diamines with dianhydrides. The dianhydrides can be any one or more selected from the group consisting of 1,2,3,4,-cyclobutanetetracarboxylic dianhydride, 1,3-dimethyl-1,2,3,4,-cyclobutanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofural)-3-methyl-3-cyclohexane-1,2-dicarboxylic dianhydride, 4,4′-oxydiphthalic anhydride (OPDA), pyromellitic dianhydride (PMDA), 3,3′,4,4′-diphenylsulfone tetracarboxylic dianhydride (DSDA), 3,3′,4,4′-benzophenone tetracarboxylic dianhydride (BTDA), 4-(2,5-dioxotetrahydrofuran-3-yl)-1,2,3,4-tetrahydronaphthalene-1,2-dicarboxylic anhydride (DTDA), 4,4′-bisphenol A dianhydride (aBPAD), 4,4′-(hexafluoroisopropylidene)diphthalic anhydride (6FDA), bicyclo[2.2.2]oct-7-ene-2,3,5,6-tetracarboxylic dianhydride (BODA), 3,3′,44′-biphenyl tetracarboxylic dianhydride (BPDA), 3,3′4,4′-bicyclohexyl tetracarboxylic dianhydride (H-BPDA) 5-(2,5-dioxotetrahydrofuryl)-3-methyl-3-cyclohexene-1,2-dicarboxylic anhydride (DOMDA), ethylene diamine tetraacetic dianhydride (EDTE), and 1,2,4,5-cyclohexanetetracarboxylic dianhydride (H-PMDA).

In one embodiment, the dianhydrides can be selected from:

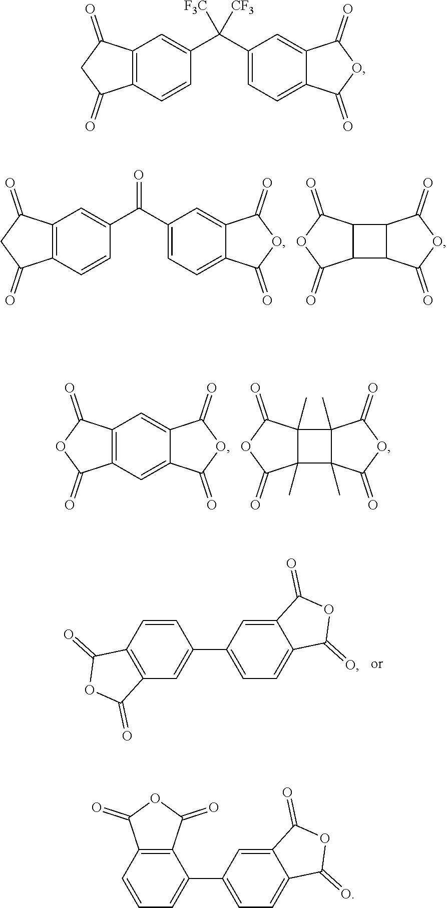

Similarly to the principle of employing various diamines to reduce undesired optical side effects, two dianhydride can be selected for the polyimide or the polyamideimde film.

The first and the second dianhydride can be in a molar ratio from 1:10 to 10:1, such as from 1:9 to 9:1, from 1:8 to 8:1, from 1:7 to 7:1, from 1:6 to 6:1, from 1:5 to 5:1, from 1:4 to 4:1, from 1:3 to 3:1, from 1:2 to 2:1, from 2:3 to 3:2, from 3:4 to 4:3, or from 4:5 to 5:4.

In yet another embodiment, a third diaanhydride can be employed. Accordingly, the first and the third dianhydride can be in a molar ratio from 1:10 to 10:1, such as from 1:9 to 9:1, from 1:8 to 8:1, from 1:7 to 7:1, from 1:6 to 6:1, from 1:5 to 5:1, from 1:4 to 4:1, from 1:3 to 3:1, from 1:2 to 2:1, from 2:3 to 3:2, from 3:4 to 4:3, or from 4:5 to 5:4. In one particular embodiment, the first, the second, and the third dianhydride are in a molar ratio of about 1:1:1.

In one embodiment, the polymer can be a polyamideimide. For such materials. Tri-carboxy monomers can be utilized to form the polyamideimide. Suitable tri-carboxy compounds are, for example,

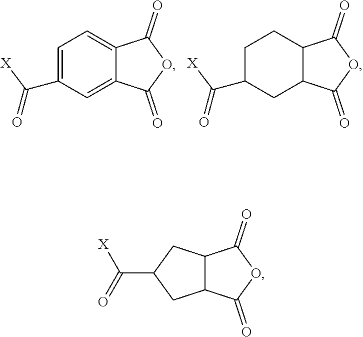

wherein X is OH, OMe, OEt, OTf, or Cl.

In one embodiment, one dianhydride and one tricarboxy compound can be selected for the polyamideimide film.

The dianhydride and the tricarboxy compound can be in a molar ratio from 1:10 to 10:1, such as from 1:9 to 9:1, from 1:8 to 8:1, from 1:7 to 7:1, from 1:6 to 6:1, from 1:5 to 5:1, from 1:4 to 4:1, from 1:3 to 3:1, from 1:2 to 2:1, from 2:3 to 3:2, from 3:4 to 4:3, or from 4:5 to 5:4.

### EXPERIMENTALS

### Example 1: Synthesis of Polyimides

The polymerization were carried out at room temperature. 0.9 equivalent of dianhydride were added as a solid to a solution of diamine followed by portionwise addition of anhydride until the reaction mixture turned into a viscous clear solution and plateaued (close to 1.0 eq of the anhydride). The reaction were run in anhydrous, freshly distilled DMAc in an amount to give 15 wt % of solid content. Films were casted on glass plates and rinsed with water, isopropanol, acetone, and water again, followed by drying using air jets to remove excess water and in an oven at 50° C. for an hour. The thickness of the films were adjusted with a 10 mil doctor blade. Films were cured in a nitrogen-purged vacuum for 2 hours at 65° C., 1 hour @ 200° C., 2 to 18 hours @ 300 m to 330° C.; cooled to less than 100° C. before removal from the oven. Plates were immersed in deionized water for at least 45 minutes before lifting the films from the glass plates and drying them on paper towels.

The following reactions were run:

p-Aminoethylaniline and 3,3′,4,4′-benzophenonetetracarboxylic dianhydride (PI-1)
p-Aminoethylaniline and 3,3′,4,4′-biphenyltetracarboxylic dianhydride (PI-2)
p-Aminoethylaniline and 1,2,3,4-cyclobutanetetracarboxylic dianhydride (PI-3)

PI-1 showed low viscosity during cast and a UV-Vis transparency of 0% at 400 nm, >60% at 500 nm, and >85% at 600 nm. PI-2 showed a T_{g} of approx. 310° C., a transparency of <5% at 400 nm, >75% at 500 nm, and >80% at 600 nm. PI-3 had a transparency of <10% at 300 nm, >50% at 400 nm, >75% at 500 nm, and >80% at 600 nm.

Polyimide films are applied in a broad spectrum of commercial industry ranging from the optical, electronic, computer or laptop or phone industry to the automotive and films for solar applications and more.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A polymer comprising a moiety selected from the group consisting of: 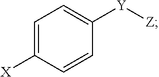
wherein
X is selected from Z, 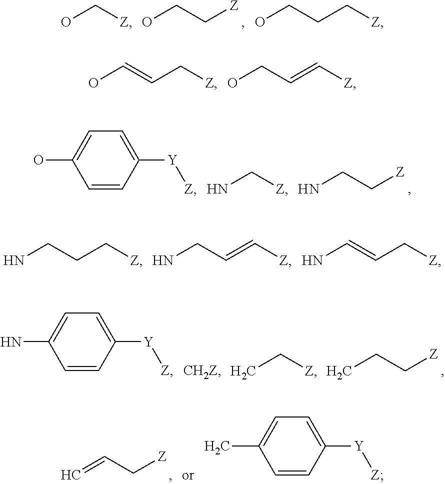
Y is selected independently for each occurrence from CH₂, CH₂CH₂, 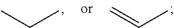
and
Z is selected independently for each occurrence from an amine, an amide, an imide, a carbamate, or a urea.

2. A polymer film comprising at least two properties selected from:
(i) a thickness of not greater than 100 μm, not greater than 90 μm, not greater than 80 μm, not greater than 70 μm, not greater than 60 μm, not greater than 50 μm, not greater than 40 μm, not greater than 35 μm, not greater than 30 μm, or not greater than 25 μm;
(ii) a tensile modulus according to ASTM D882 of at least 5 GPa, at least 5.2 GPa, at least 5.4 GPa, at least 5.6 GPa, at least 5.8 GPa, at least 6 GPa, at least 6.2 GPa, at least 6.4 GPa, at least 6.6 GPa, at least 6.8 GPa, at least 7 GPa, at least 7.2 GPa, at least 7.4 GPa, at least 7.6 GPa, at least 7.8 GPa, at least 8 GPa, at least 8.2 GPa, at least 8.5 GPa, at least 9 GPa, or at least 10 GPa;
(iii) a first optical transparency according to ASTM D1746-15 at 380 nm of less than 50%, less than 40%, less than 35%, less than 30%, less than 25%, less than 20%, less than 15%, less than 10%, less than 8%, less than 6%, less than 4%, less than 2%, or less than 1%, and a second optical transparency according to ASTM D1746-15 at 400 nm of greater than 50%, greater than 60%, greater than 70%, greater than 80%, greater than 82%, greater than 84%, greater than 86%, greater than 88%, greater than 90%, greater than 92%, greater than 94%, greater than 96%, or greater than 96%;
(iii) a Yellowing Index according to ASTM E313-15e1 of not greater than 2.5, not greater than 2.4, not greater than 2.3, not greater than 2.2, not greater than 2.1, not greater than 2.0, not greater than 1.9, not greater than 1.8, not greater than 1.7, not greater than 1.6, not greater than 1.5, not greater than 1.4, or not greater than 1.3;
(iv) a haze as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%;
(v) a pencil hardness of greater than 1H, greater than 2H, greater than 3H, greater than 4H, greater than 5H, or greater than 6H;
(vi) a coefficient of moisture expansion (‘CME’) as determined according to ASTM D5229/D5229M-14 of not greater than 50 ppm, not greater than 45 ppm, not greater than 40 ppm, not greater than 35 ppm, not greater than 30 ppm, not greater than 25 ppm, not greater than 20 ppm, or not greater than 15 ppm;
(vii) an elongation at break as determined according to ASTM D5034-09 (2017) of at least 10%, at least 15%, at least 20%, at least 22%, at least 24%, at least 26%, at least 28%, at least 30%, at least 35%, or at least 40%; or
(viii) a folding endurance as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

3. The polymer film according to claim 2, comprising at least three properties selected from (i) through (viii), at least four properties selected from (i) through (viii), at least five properties selected from (i) through (viii), at least six properties selected from (i) through (viii), at least seven properties selected from (i) through (viii), or all properties selected from (i) through (viii).

4. A method for making an optically transparent films comprising:
polymerizing a first copolymer with a second copolymer, wherein the first copolymer is selected from the group consisting of: 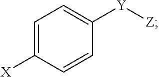
wherein
X is selected from Z, 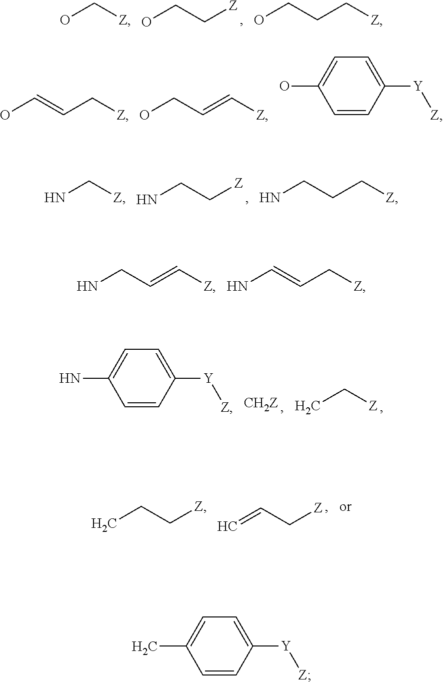
Y is selected independently for each occurrence from CH₂, CH₂CH₂, 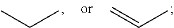
and
Z is selected independently for each occurrence from an amine or a hydroxyl.

5. The method according to claim 4 wherein the first copolymer is selected from 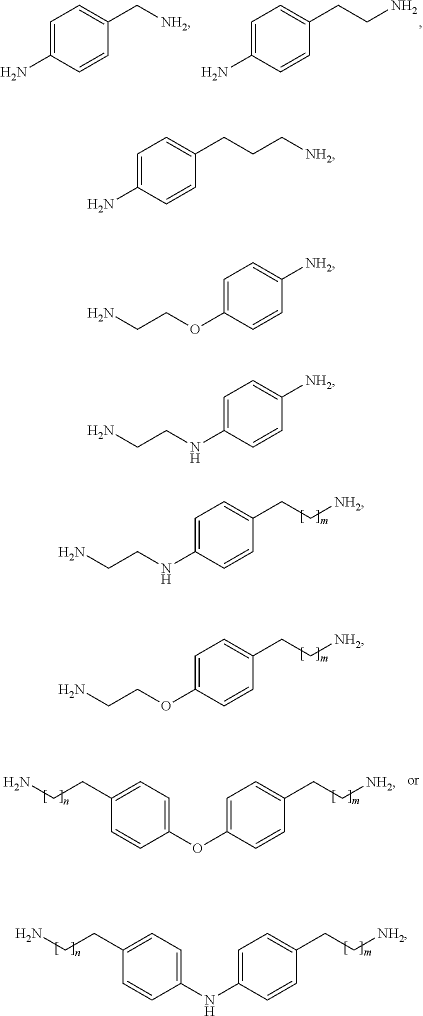
wherein m and n are independently for each occurrence selected from 0, 1, 2, 3, or 4.

6. The method according to claim 4, wherein the second polymer is selected from 1,2,3,4,-cyclobutanetetracarboxylic dianhydride, 1,3-dimethyl-1,2,3,4,-cyclobutanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofural-3-methyl-3-cyclohexane-1,2-dicarboxylic dianhydride, 4,4′-oxydiphthalic anhydride (OPDA), pyromellitic dianhydride (PMDA), 3,3′,4,4′-diphenylsulfone tetracarboxylic dianhydride (DSDA), 3,3′,4,4′-benzophenone tetracarboxylic dianhydride (BTDA), 4-(2,5-dioxotetrahydrofuran-3-yl)-1,2,3,4-tetrahydronaphthalene-1,2-dicarboxylic anhydride (DTDA), 4,4′-bisphenol A dianhydride (aBPAD), 4,4′-(hexafluoroisopropylidene)diphthalic anhydride (6FDA), bicyclo[2.2.2]oct-7-ene-2,3,5,6-tetracarboxylic dianhydride (BODA), 3,3′,4,4′-biphenyl tetracarboxylic dianhydride (BPDA), 3,3′4,4′-bicyclohexyl tetracarboxylic dianhydride (H-BPDA) 5-(2,5-dioxotetrahydrofuryl)-3-methyl-3-cyclohexene-1,2-dicarboxylic anhydride (DOMDA), ethylene diamine tetraacetic dianhydride (EDTE), and 1,2,4,5-cyclohexanetetracarboxylic dianhydride (H-PMDA).

7. The method according to claim 4, wherein the second polymer is selected from

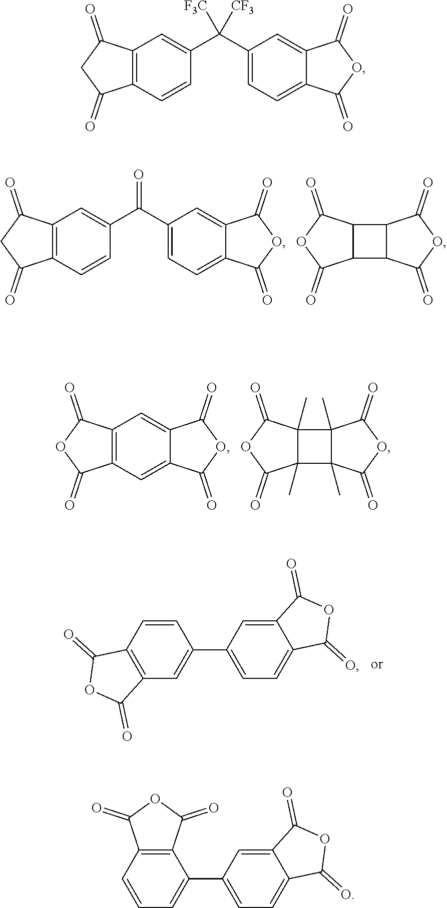

8. The method according to claim 4, further comprising a third copolymer independent and different from the first copolymer.

9. The method according to claim 8, wherein the third copolymer is selected from 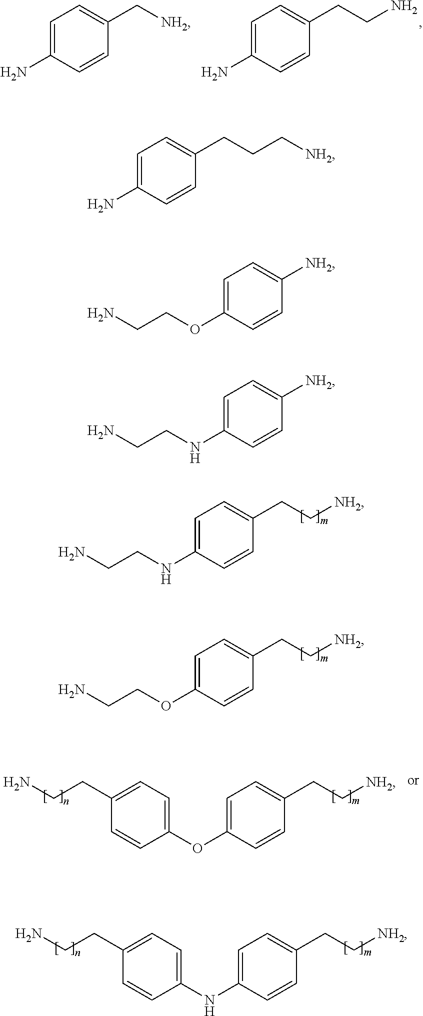
wherein m and n are independently for each occurrence selected from 0, 1, 2, 3, or 4.

10. The method according to claim 8, wherein the first and the third copolymer are in a molar ratio from 1:10 to 10:1, such as from 1:5 to 5:1, 1:3 to 3:1, or 1:2 to 2:1.
